(19) United States
(12) Patent Application Publication
(10) Pub. No.: US 2018/0329900 A1
(43) Pub. Date: Nov. 15, 2018

(54) PREDICTION MODELS FOR CONCURRENCY CONTROL TYPES

(71) Applicant: ENTIT SOFTWARE LLC, SANFORD, NC (US)

(72) Inventor: Ofer SPIEGEL, Yehud (IL)

(21) Appl. No.: 15/776,567

(22) PCT Filed: Nov. 19, 2015
(86) PCT No.: PCT/US2015/061651

§ 371 Date: May 16, 2018

(51) Int. Cl. G06F 17/30; G06F 15/18; G06K 9/62; G06N 7/00

(52) U.S. Cl. CPC G06F 17/30008; G06N 7/00; G06K 9/6256; G06F 15/18

(57) ABSTRACT

Examples disclosed herein relate to prediction models concurrency control types. Some of the examples enable generating a prediction model based on training data. The training data may comprise a set of access data associated with a data object. The set of access data may comprise: values for a set of attributes of the data object, and an indication whether a conflict occurred during processing of a request to access the data object.

### BACKGROUND

Concurrency control is a mechanism that manages and coordinates concurrent accesses to a database in a multi-user database management system (DBMS). In multi-user DBMS environments, database updates performed by one user may conflict with database retrievals and updates performed by another. Concurrency control allows multiple users to simultaneously access the same database while preserving the illusion that each user is executing alone on a dedicated system.

### BRIEF DESCRIPTION OF THE DRAWINGS

The following detailed description references the drawings wherein:

FIG. 1 is a block diagram depicting an example environment in which various examples may be implemented as a prediction model system.

FIG. 2 is a block diagram depicting an example prediction model system.

FIG. 3 is a block diagram depicting air example machine-readable storage medium comprising instructions executable by a processor for generating prediction models for concurrency control types.

FIG. 4 is a block diagram depicting an example machine-readable storage medium comprising instructions executable by a processor for generating prediction models for concurrency control types.

FIG. 5 is a flow diagram depicting an example method for generating prediction models for concurrency control types.

FIG. 6 is a flow diagram depicting an example method for generating prediction models for concurrency control types.

FIG. 7 is a table depicting example data objects.

FIG. 8 is a table depicting example data objects.

### DETAILED DESCRIPTION

The following detailed description refers to the accompanying drawings. Wherever possible, the same reference numbers are used in the drawings and the following description to refer to the same or similar parts. It is to be expressly understood, however, that the drawings are for the purpose of illustration and description only. While several examples are described in this document, modifications, adaptations, and other implementations are possible. Accordingly, the following detailed description does not limit the disclosed examples. Instead, the proper scope of the disclosed examples may be defined by the appended claims.

Concurrency control is a mechanism that manages and coordinates concurrent accesses to a database in a multi-user database management system (DBMS). In multi-user DBMS environments, database updates performed by one user may conflict with database retrievals and updates performed by another. Concurrency control allows multiple users to simultaneously access the same database while preserving the illusion that each user is executing alone on a dedicated system.

Example types of concurrency control may include a pessimistic concurrency control type and an optimistic concurrency control type. In pessimistic concurrency control, data may be marked as locked while it is being updated by a user. Other users cannot perform actions that would conflict with the lock until that user commits the update and/or releases the lock. In optimistic concurrency control, before a user commits an update, the system verifies that no other transaction has modified the data being read by the update transaction. If the verification reveals conflicting updates to the same data, the update transaction would be rejected (e.g., the user receives an error). The user may roll back the rejected transaction and start over.

The pessimistic control type assures data integrity in the price of reduced concurrency (e.g., having transactions wait for other transactions' locks to clear) and/or reduced performance (e.g., managing locks). Thus, the optimistic concurrency control type is generally used in environments with low data contention (e.g., less likelihood of update conflicts). When conflicts are rare, transactions can complete without the expense of reduced concurrency and performance. However, when conflicts are frequent (e.g., greater likelihood of update conflicts), the pessimistic control type may be a better fit because the cost of repeatedly restarting transactions would significantly hurt performance. Although a particular type of concurrency control could be selected to handle all of the transactions occurring in a database and/or being initiated by an application, it is technically challenging to dynamically determine a concurrency control type to be used for individual data objects.

Examples disclosed herein provide technical solutions to these technical challenges by generating prediction models for concurrency control types. Some of the examples disclosed herein may enable generating a prediction model based on training data. The training data may comprise a set of access data associated with a data object. The set of access data may, comprise: values for a set of attributes of the data object, and an indication whether a conflict occurred during processing of a request to access the data object. In some instances, the set of access data may further include contextual data including, but not being limited to, of access, and geographical location of the user who requests the access. The prediction model may then determine a probability of a conflict occurring during processing of a request to access another data object. Based on the determined probability of the conflict, a concurrency control type to be used to process this request may be determined.

The terminology used herein is for the purpose of describing particular embodiments only and is not intended to be limiting. As used herein, the singular forms “a,” “an” and “the” are intended to include the plural forms as well, unless the context clearly indicates otherwise. The term “plurality,” as used herein, is defined as two or more than two. The term “another,” as used herein, is defined as at least a second or more. The term “coupled,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers and encompasses any and all possible combinations of one or more of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

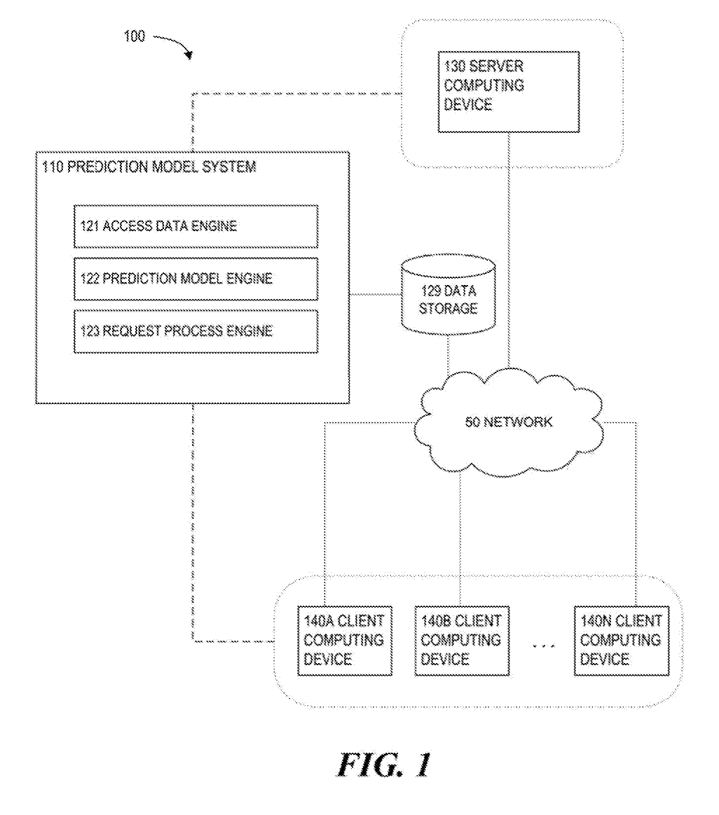

FIG. 1 is an example environment 100 in which various examples may be implemented as a prediction model system 110. Environment 100 may include various components including server computing device 130 and client computing devices 140 (illustrated as 140A, 140B, . . . , 140N). Each client computing device 140A, 140B, . . . , 140N may communicate requests to and/or receive responses from server computing device 130. Server computing device 130 may receive and/or respond to requests from client computing devices 140. Client computing devices 140 may be any type of computing device providing a user interface through which a user can interact with a software application. For example, client computing devices 140 may include a laptop computing device, a desktop computing device, an all-in-one computing device, a thin client, a workstation, a tablet computing device, a mobile phone, an electronic book reader, a network-enabled appliance such as a “Smart” television, and/or other electronic device suitable for displaying a user interface and processing user interactions with the displayed interface. While server computing device 130 is depicted as a single computing device, server computing device 130 may include any number of integrated or distributed computing devices serving at least one software application for consumption by client computing devices 140.

The various components (e.g., components 129, 130, and/or 140) depicted in FIG. 1 may be coupled to at least one other component via a network 50. Network 50 may comprise any infrastructure or combination of infrastructures that enable electronic communication between the components. For example, network 50 may include at least one of the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. According to various implementations, prediction model system 110 and the various components described herein may be implemented in hardware and/or a combination of hardware and programming that configures hardware. Furthermore, in FIG. 1 and other Figures described herein, different numbers of components or entities than depicted may be used.

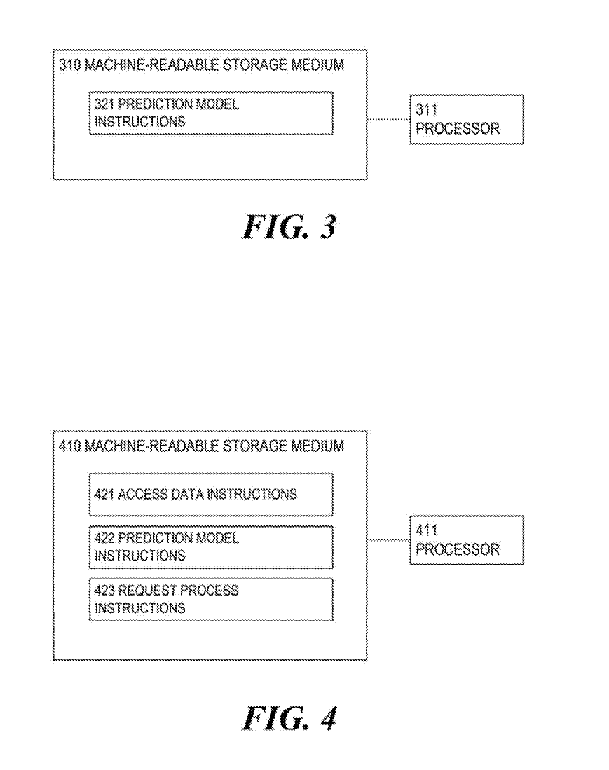

Prediction model system 110 may comprise an access data engine 121, a prediction model engine 122, a request process engine 123, and/or other engines. The term “engine”, as used herein, refers to a combination of hardware and programming that performs a designated function. As is illustrated respect to FIGS. 3-4, the hardware of each engine, for example, may include one or both of a processor and a machine-readable storage medium, while the programming is instructions or code stored on the machine-readable storage medium and executable by the processor to perform the designated function.

Access data engine 121 may identify access data associated with various data objects. For example, access data engine 121 may identify a first set of access data associated with a first data object. The first set of access data may comprise: values for a first set of attributes of the first data object, a concurrency control type that was used to process a request to access the first data object, and/or an indication of whether a conflict occurred during processing of the request to access the first data object.

A “request to access” a particular data object, as used herein, may include a request to read, delete, and/or update the data object and/or other database transaction related to the data object.

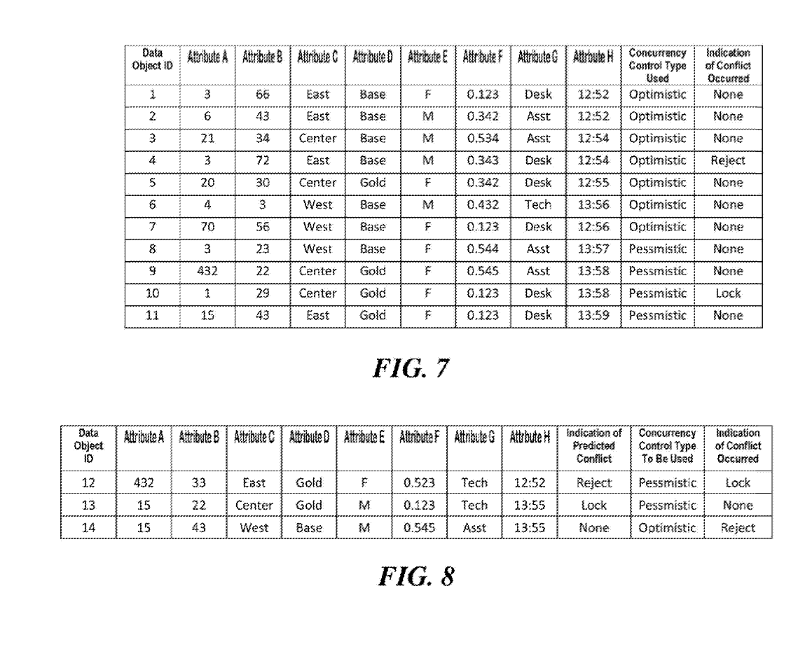

A “concurrency control type that was used to process a request to access a particular data object,” as used herein, may comprise a pessimistic concurrency control type, an optimistic concurrency control type, and/or other types of concurrency control. For example, in pessimistic concurrency control, data may be marked as locked while it is being updated by a user. Other users cannot perform actions that would conflict with the lock until that user commits the update and/or releases the lock. In optimistic concurrency control, before a user commits an update, the system verifies that no other transaction has modified the data being read by the update transaction. If the verification reveals conflicting updates to the same data, the update transaction would be rejected (e.g., the user receives an error). The user may roll back the rejected transaction and start over. Note that although two concurrency control types (e.g., pessimistic and optimistic types) are discussed in the examples described herein (e.g., examples illustrated in FIGS. 7-8), other types of concurrency control known in the art are also contemplated.

An “indication of a conflict that occurred,” as used herein, may comprise: a first indication that no occurrence of a conflict was detected during processing of a request to access a particular data object (e.g., denoted by “None”), a second indication that an occurrence of a conflict was detected during the processing (e.g., denoted by “Conflict”), and/or other indications of a conflict. In some implementations, the second indication may indicate a type of a conflict that occurred: that the conflict occurred due to a locking of that particular object (e.g., denoted by “Lock”), that the conflict occurred due to a rejection of an update to the particular data object (e.g., denoted by “Reject”), and/or other types of a conflict.

Suppose that an example dataset as illustrated in FIG. 7 represents access data associated with 11 data objects (e.g., Data Object IDs #1-11), In one example, for Data Object ID #1 (e.g., the first data object), the data object is associated with a set of attributes including Attributes A-H. The values of Attributes A-H include: 3, 66, East, Base, F. 0.123. Desk, and 12:52, respectively, The access data may further include a concurrency control type (e.g., optimistic concurrency control) that was used during processing of a request to access Data Object ID #1. The access data may further include an indication of whether a conflict actually occurred (e.g., “None” meaning no conflict occurred) during the processing (e.g., given that the optimistic concurrency control was used). In another example, for Data Object ID #4 (e.g., a second data object), the data object is associated with a set of attributes including Attributes A-H. The values of Attributes A-H include: 3, 72, East. Base, M, 0.343, Desk, and 12:54, respectively. The access data may further include a concurrency control type (e.g., optimistic concurrency control) that was used during processing of a request to access Data Object ID #4. The access data may further include an indication of whether a conflict actually occurred (e.g., “Reject” meaning the access request was rejected) during the processing (e.g., given that the optimistic concurrency control was used). In yet another example, for Data Object ID #10 (e.g., a third data object), the data object is associated with a set of attributes including Attributes A-H. The values of Attributes A-H include: 1, 29, Center, Gold, F, 0.123, Desk, and 13:58,respectively. The access data may further include a concurrency control type (e.g., pessimistic concurrency control) that was used during processing of a request to access Data Object ID #10. The access data may further include an indication of whether a conflict actually occurred (e.g., “Lock” meaning Data Object ID #10 is locked by another user) during the processing (e.g., given that the pessimistic concurrency control was used).

The access data of various data objects like the example dataset shown in FIG. 7 may be used as training data to train a prediction model, as further discussed herein with respect to prediction model engine 122.

Prediction model engine 122 may generate, using a machine-learning algorithm, a prediction model based on the training data that includes the access data (e.g., identified by access data engine 121). Any machine-learning algorithm known in the art may be used to generate a prediction model. The prediction model may be trained to recognize patterns in the training data. In some implementations, a trained prediction model may be tested using test data to ensure that its output is validated within an acceptable margin of error. A properly trained and/or tested prediction model may use the knowledge discovered from the training data to predict an output (e.g., an indication of whether a conflict Is predicted to occur) given a new data object and/or given at least a portion of its access data (e.g., values for a set of attributes of the new data object). Prior to processing a request to access a new data object, the new data object may be identified and/or submitted to the prediction model to predict an indication of whether a conflict is predicted to occur. Based on this indication of a predicted conflict, prediction model engine 122 may determine a concurrency control type to be used to process the request to access that new data object.

An “indication of a conflict that is predicted to occur,” as used herein, may comprise: a first indication that no conflict is predicted to occur during processing of a request to access a particular data object (e.g., denoted by “None”, a second indication that a conflict is predicted to occur during the processing (e.g., denoted by “Conflict”), and/or other indications of a conflict. In some implementations, the second indication may indicate a type of a conflict that is predicted to occur: that the conflict is predicted to occur due to a locking of that particular object (e.g., denoted by “Lock”), that the conflict is predicted to due to a rejection of an update to the particular data object (e.g., denoted by “Reject”), and/or other types of a conflict.

For example, suppose that an example dataset as illustrated in FIG. 8 includes 3 new data objects (e.g., Data Object IDs #12-14) for which a concurrency control type should be determined using the prediction model. Data Object ID #12 having values for Attributes A-H (e.g., 432, 33, East. Gold, F, 0.523,Tech, and 12:52, respectively) may be submitted to the prediction model (e.g., that has been trained and/or tested by prediction model engine 122 as discussed above). The prediction model may analyze patterns in the values for those attributes and use the result of the analysis to predict an indication of whether a conflict is predicted to occur during processing of a request to access Data Object ID #12. In other words, the prediction model may determine a probability of a conflict occurring during the processing of the request to access Data Object ID #12.

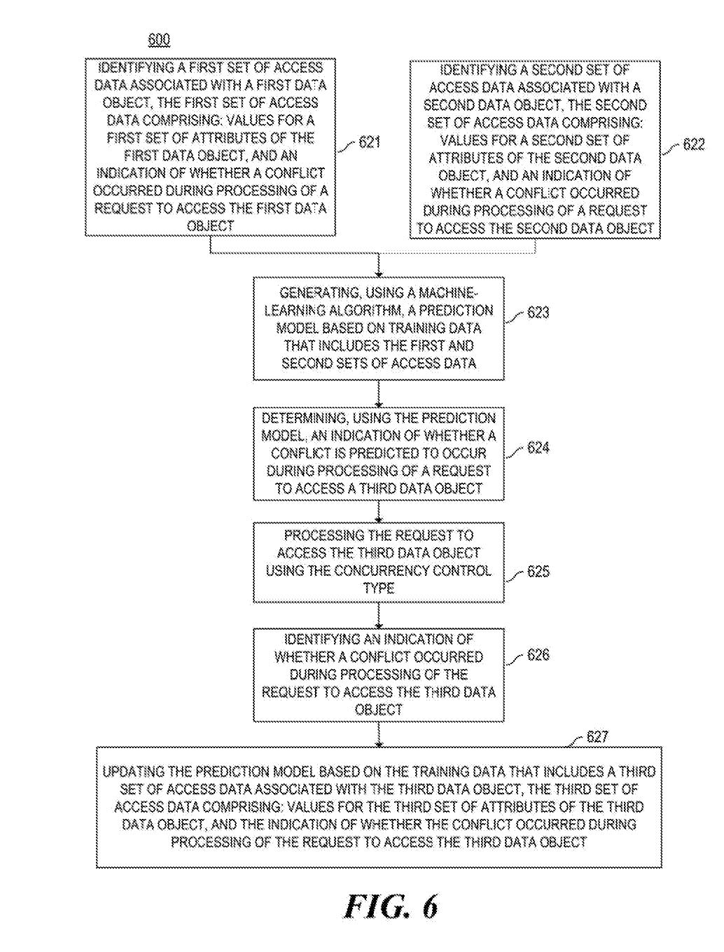

In the example illustrated in FIG. 6, the prediction model, based on the values of the attributes associated with Data Object ID #12, determines that a conflict (e.g., “Reject”) is predicted to occur during processing of the request to access Data Object ID #12. Based on the conflict (e.g., “Reject”) that is predicted to occur, prediction model engine 122 may select a particular type of concurrency control (e.g., pessimistic) to process the request to access Data Object ID #12.

With respect to Data Object ID #13 in FIG. 8, in response to determining that a conflict (e.g., “Lock”) is predicted to occur during processing of a request to access Data Object ID #13 using the prediction model, prediction model engine 122 may determine that the pessimistic concurrency control type should be used to process the request to access Data Object ID #13 given the indication that a conflict is likely to occur. On the other hand, with respect to Data Object ID #14 in FIG. 8, prediction model engine 122 determines that no conflict (e.g., “None”) is predicted to occur based on the values of attributes associated with Data Object ID #14. In response to that indication, prediction model engine 122 may select a particular type of concurrency control (e.g., optimistic).

Request process engine 123 may process a request access a data object. For example, request process engine 123 may read, delete, and/or update the data object according to the request. The processing may result in the requested transaction being successfully committed or in the requested transaction failing to commit (e.g., because a conflict occurred). During processing of a request to access a data object, request process engine 123 may use a particular concurrency control type that has been selected, determined, and/or suggested by prediction model engine 122 for that particular data object, Returning to the example illustrated in FIG. 8, request process engine 123 may process a request to access Data Object ID #12 using the pessimistic concurrency control type (e.g., which was selected based on the indication that a conflict, “Reject,” was predicted to occur).

In some implementations, after applying the concurrency control type that was selected, determined, and/or suggested by prediction model engine 122 to process a request to access a new data object, prediction model engine 122 may monitor for an indication of whether a conflict actually occurred or not during the processing of the request to access the new data object. Returning to the example illustrated in FIG. 8, after applying the pessimistic concurrency control type in processing a request to access Data Object ID #12, an occurrence of a conflict (e.g., “Lock”) was detected. This information may be included in the training data so that the prediction model may be continuously trained, tested, and/or improved. As such, prediction model engine 122 may update the prediction model based on the training data that includes a set of access data associated with Data Object ID #12. The set of access data may comprise: values for the set of attributes of Data Object ID (e.g., 432, 33, East, Gold, F, 0.523,Tech, and 12:52), a concur y control type (e.g., pessimistic), and/or an indication of whether a conflict occurred during processing of the request access Data Object ID #12 (e.g., “Lock”).

In performing their respective functions, engines 121-123 may access data storage 129 and/or other suitable database(s). Data storage 129 may represent any memory accessible to prediction model system 110 that can be used to store and retrieve data. Data storage 129 and/or other database may comprise random access memory (RAM), read-only memory (ROM), electrically-erasable programmable read-only memory (EEPROM), cache memory, floppy disks, hard disks, optical disks, tapes, solid state drives, flash drives, portable compact disks, and/or other storage media for storing computer-executable instructions and/or data Prediction model system 1 may access data storage 129 locally or remotely via network 50 or other networks

Data storage 129 may include a database to organize and store data. The database may reside in a single or multiple physical device(s) and in a single or multiple physical location(s), The database may store a plurality of types of data and/or files and associated data or file description, administrative information, or any other data.

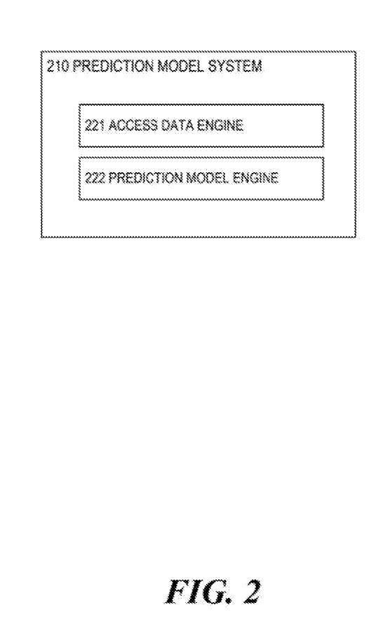

FIG. 2 is a block diagram depicting an example prediction model system 210 Prediction model system 210 may comprise an access data engine 221, a prediction model engine 222, and/or other engines. Engines 221-222 represent engines 121-122, respectively,

FIG. 3 is a block diagram depicting an example machine-readable storage medium 310 comprising instructions executable by a processor for generating prediction €reals for concurrency control types.

In the foregoing discussion, engines 121-123 were described as combinations of hardware and programming. Engines 121-123 may be implemented in a number of fashions. Referring to FIG. 3, the programming may be processor executable instructions 321 stored on a machine-readable storage medium 310 and the hardware may include a processor 311 for executing those instructions. Thus, machine-readable storage medium 310 can be said to program instructions or code that when executed by processor 311 implements prediction model system 110 of FIG. 1.

In FIG. 3, the executable program instructions in machine-readable storage medium 310 are depicted as prediction model instructions 321. Instructions 321 represent program instructions that, when executed, cause processor 311 to implement engine 122.

FIG. 4 is a block diagram depicting an example machine-readable storage medium 410 comprising instructions executable by a processor for generating prediction models for concurrency control types.

Referring to FIG. 4, the programming may be processor executable instructions 421-423 stored on a machine-readable storage medium 410 and the hardware may include a processor 411 for executing those instructions. Thus machine-readable storage medium 410 can be said to store program instructions code that when executed by processor 411 implements prediction model system 110 of FIG. 1.

In FIG. 4, executable program instructions in machine-readable storage medium 410 are depicted as access data instructions 421, prediction model instructions 422, and request process instructions 423. Instructions 421-423 represent program instructions that, when executed, cause processor 411 to implement engines 121-123, respectively.

Machine-readable storage medium 310 (or machine-readable storage medium 410) may be any electronic, magnetic, optical, or other physical storage device that contains or stores executable instructions. In some implementations, machine-readable storage medium 310 (or machine-readable storage medium 410) may be a non-transitory storage medium, where the term “non-transitory” does not encompass transitory propagating signals. Machine-readable storage medium 310 (or machine-readable storage medium 410) may be implemented in a single device or distributed across devices. Likewise, processor 311 (or processor 411) may represent any number of processors capable of executing instructions stored by machine-readable storage medium 310 (or machine-readable storage medium 410). Processor 311 (or processor 411) may be integrated in a single device or distributed across devices, Further, machine-readable storage medium 310 (or machine-readable storage medium 410) may be fully or partially integrated in the same device as processor 311 (or processor 411) or it may be separate but accessible to that device and processor 311 (or processor 411).

In one example, the program it instructions may be part of an installation package that when installed can be executed by processor 311 (or processor 411) to implement prediction model system 110. In this case, machine-readable storage medium 310 (or machine-readable storage medium 410) may be a portable medium such as a floppy disk, CD, DVD, or flash drive or a memory maintained by a server from which the installation package can be downloaded and installed. In another example, the program instructions may be part of an application or applications already installed. Here, machine-readable storage medium 310 (or machine-readable storage medium 410) may include a hard disk, optical disk, tapes, solid state drives, RAM, ROM, EEPROM, or the like.

Processor 311 may be at least one central processing unit (CPU), microprocessor, and/or other hardware device suitable for retrieval and execution of instructions stored in machine-readable storage medium 310. Processor 311 may fetch, decode, and execute program instructions 321, and/or other instructions. As an alternative or in addition to retrieving and executing instructions, processor 311 may include at least one electronic circuit comprising a number of electronic components for performing the functionality of instructions 321, and/or other instructions.

Processor 411 may be at least one central processing unit (CPU), microprocessor, and/or other hardware device suitable for retrieval and execution of instructions stored in machine-readable storage medium 410. Processor 411 may fetch, decode, and execute program instructions 421-423, and/or other instructions. As an alternative or in addition to retrieving and executing instructions, processor 411 may include at least one electronic circuit comprising a number of electronic components for performing the functionality of at least one of instructions 421-423, and/or other instructions.

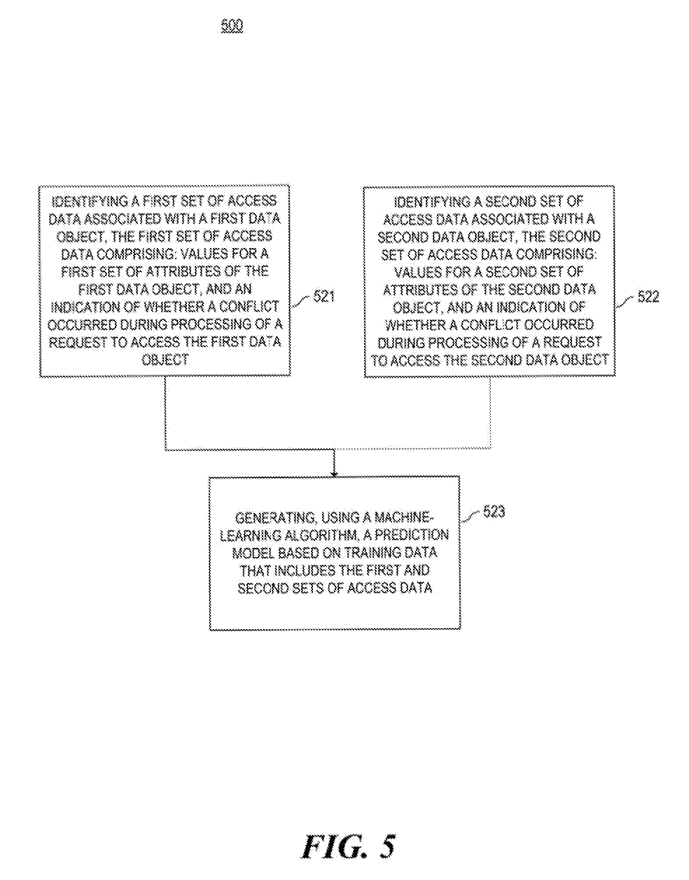

FIG. 5 is a flow diagram depicting an example method 500 for generating prediction models for concurrency control types. The various processing blocks and/or data flows depicted in FIG. 5 (and in the other drawing figures such as FIG. 6) are described in greater detail herein. The described processing blocks may be accomplished using some or all of the system components described in detail above and, in some implementations, various processing blocks may be performed in different sequences and various processing blocks may be omitted. Additional processing blocks may be performed along with some or all of the processing blocks shown in the depicted flow diagrams. Some processing blocks may be performed simultaneously. Accordingly, method 500 as illustrated (and described in greater detail below) is meant to be an example and, as such, should not be viewed as limiting. Method 500 may be implemented in the form of executable instructions stored on a machine-readable storage medium such as storage medium 310, and/or in the form of electronic circuitry.

In block 521, method 500 may include identifying a first set of access data associated with a first data object. The first set of access data may comprise: values for a first set of attributes of the first data object, and an indication of whether a conflict occurred during processing of a request to the first data object. Referring back to FIG. 1 access data engine 121 may be responsible for implementing block 521.

In block 522, method 500 may include identifying second access data associated with a second data object. The second set of access data may comprise: values for a second set of attributes of the second data object, and an indication of whether a conflict occurred during processing of a request to access the second data object. Referring back to FIG. 1, access data engine 121 may be responsible for implementing block 522.

In block 523, method 500 may include generating, using a machine-learning algorithm, a prediction model based on training data that includes the first and second sets of access data. Referring back to FIG. 1, prediction model engine 122 may be responsible for implementing block 523.

FIG. 6 is a flow diagram depicting an example method 600 for generating prediction models for concurrency control types. Method 600 as illustrated (and described in greater detail below) is meant to be an example and, as such, should not be viewed as limiting. Method 600 may be implemented in the form of executable instructions stored on a machine-readable storage medium, such as storage medium 310, and/or in the form of electronic circuitry.

In block 621, method 600 may include identifying a first set of access data associated with a first data object. The first set of access data may comprise: values for a first set of attributes of the first data object, and an indication of whether a conflict occurred during processing of a request to access the first data object. Referring back to FIG. 1, access data engine 121 may be responsible for implementing block 621.

In block 622, method 600 may include identifying a second set of access data associated with a second data object. The second set of access data may comprise: values for a second set of attributes of the second data object, and an indication of whether a conflict occurred during processing of a request to access the second data object. Referring back to FIG. 1, access data engine 121 may be responsible for implementing block 622.

In block 623, method 600 may include generating, using a machine-learning algorithm, a prediction model based on training data that includes the first and second sets of access data. Referring back to FIG. 1, prediction model engine 122 may be responsible for implementing block 623.

In block 624, method 600 may include determining, using the prediction model, an indication of whether a conflict is predicted to occur during processing of a request to access to a third data object. Referring back to FIG. 1, prediction model engine 122 may be responsible for implementing block 624.

In block 625, method 600 may include processing the request to access the third data object using the concurrency control type. Referring back to FIG. 1, request process engine 123 may be responsible for implementing block 625.

In block 626, method 600 may include identifying an indication of whether a conflict occurred during processing of the request to access the third data object. Referring back to FIG. 1, request process engine 123 may be responsible for implementing block 626.

In block 627, method 600 may include updating the prediction model based on the training data that includes a third set of access data associated with the third data object. The third set of access data may comprise: value for the third set attributes of the third data object, and the indication of whether the conflict occurred during processing of the request to access the third data object. Referring back to FIG. 1, prediction model engine 122 may be responsible for implementing block 627.

FIGS. 7-8 are discussed herein with respect to FIG. 1.

The foregoing disclosure describes a number of example implementations for prediction models for concurrency control types. The disclosed examples may include systems, devices, computer-readable storage media, and methods for prediction models for concurrency control types. For purposes of explanation, certain examples are described with reference to the components illustrated in FIGS. 1-4. The functionality of the illustrated components may overlap, however, and may be present in a fewer or greater number of elements and components.

Further, all or part of the functionality of illustrated elements may co-exist or be distributed among several geographically dispersed locations. Moreover, the disclosed examples may be implemented in various environments and are not limited to the illustrated examples. Further, the sequence of operations described in connection with FIGS. 5-6 are examples and are not intended to be limiting. Additional or fewer operations or combinations o operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples. All such modifications and variations are intended to be included within the scope of this disclosure and protected by the following claims.

1. A method for generating prediction models for concurrency control types, the method comprising:
identifying a first set of access data associated with a first data object, the first set of access data comprising: values for a first set of attributes of the first data object, and an indication of whether a conflict occurred during processing of a request to access the first data object
identifying a second set of access data associated with a second data object, the second set of access data comprising: values for a second set of attributes of the second data object, and an indication of whether a conflict occurred during processing of a request to access the second data object: and
generating, using a machine-learning algorithm, a prediction model based on training data that includes the first and second sets of access data.

2. The method of claim 1, further comprising:
determining, using the prediction model, an indication of whether a conflict is predicted to occur during processing of a request to access a third data object: and
determining, based on the determined indication, a concurrency control type to be used to process the request to access the third data object.

3. The method of claim 2, wherein determining, using the prediction model, the indication of whether the conflict is predicted to occur further comprises:
identifying values for a third set of attributes of the third data object; and
determining, using the prediction model, the indication of whether the conflict is predicted to occur based on the values for the third set of attributes.

4. The method of claim 2, further comprising:
processing the request to access the third data object using the concurrency control type;
identifying an indication of whether a conflict occurred during processing of the request to access the third data object, and
updating the prediction model based on the training data that includes a third set of access data associated with the third data object, the third set access data comprising: values for the third set of attributes of the third data object, and the indication of whether the conflict occurred during processing of the request to access the third data object.

5. The method of claim 2, wherein the concurrency control type comprises a pessimistic concurrency control type or an optimistic concurrency control type

6. The method of claim 2, wherein the indication of whether the conflict is predicted to occur during processing of the request to access the third data object comprises a first indication that no conflict is predicted to occur, a second indication that the conflict is predicted to occur due to a locking of the third data object, or a third indication that the conflict is predicted to occur due to a rejection of an update to the d data object,

7. The method of claim 6, further comprising;
in response to the first indication, processing the request to access the third data object using an optimistic concurrency control type; and
in response to the second or third indication, processing the request to access the third data object using a pessimistic concurrency control type.

8. A non-transitory machine-readable storage medium comprising instructions executable by a processor of a computing device for generating prediction models for concurrency control types, the machine-readable storage medium comprising:
instructions to identify a predict n model that is generated based on training data comprising: i) values for a first set of attributes of the first data object, and (ii) an indication of whether a conflict occurred during processing of a request to access the first data object;
instructions to determine, using the prediction model, a probability of a occurring during processing of a request to access a second data object; and
instructions to determine, based on the probability of the conflict for the second data object, a concurrency control type to be used to process the request to access the second data object

9. The non-transit machine-readable storage medium of claim 8, further comprising:
instructions to process the request access the second data object using the concurrency control type;
instructions to identify an indication of whether a conflict occurred during processing of the request to access the second data object; and
instructions to include a second set of access data associated with the second data object in the training data, the second set of access data comprising: values for a second set of attributes of the second data object, and the indication of whether the conflict occurred during processing of the request to access the second data object.

10. The non-transitory machine-readable storage medium of claim 8, wherein the second data object includes values of a second set of attributes of the second data object, further comprising:
instructions to use the values of the second set of attributes to determine the probability of the conflict occurring during processing of the request to access the second data object.

11. The non-transitory machine-readable storage medium of claim 8, further comprising:
instructions to determine, using the prediction model, a probability of a conflict occurring during processing of a request to access a third data object; and
instructions to determine, based on the probability of the conflict for the third data object, a concurrency control type to be used to process the request to access the third data object.

12. A system for generating prediction models for concurrency control types comprising:
a processor that:
identifies a first set of access data associated with a first data object, the first set of access data comprising: values for a first set of attributes of the first data object, and an indication of whether a conflict occurred during processing of a request to access the first data object;
generates, using a machine-learning algorithm, a prediction model based on training data that includes the first set of access data;
identifies a second data object;
determines, using the prediction model, an indication of whether a conflict is predicted to occur during processing of a request to access the second data object; and
determines, based on the determined indication, the concurrency control type to be used to process the request to access the second data object.

13. The system of claim 12, herein the first set of access data comprises a concurrency control type that was used to process the request to access the first data object.

14. The system of claim 12, the processor that:
identifies a third data object for which a concurrency control type is determined using the prediction model;
determines, using the prediction model, an indication of whether a conflict is predicted to occur during processing of a request to access the third data object; and
determines, based on the determined indication, the concurrency control type to be used to process the request to access the third data object.

15. The system of claim 14, wherein the determination of the concurrency control type for the second data object and the determination of the concurrency control type for the third data object occur within a designated time period prior to processing of the request to access the second and third data objects.
